(19) United States
(12) Patent Application Publication
(10) Pub. No.: US 2017/0362865 A1
(43) Pub. Date: Dec. 21, 2017

(54) HINGED DOOR FIXING APPARATUS FOR PREVENTING HINGED DOOR FROM BEING AUTOMATICALLY CLOSED

(71) Applicant: LFIA, Goyang-si Gyeonggi-do (KR)

(72) Inventor: Ju Hyun LEE, Namyangju-si, Gyeonggi-do (KR)

(73) Assignee: LFIA, Goyang-si Gyeonggi-do (KR)

(21) Appl. No.: 15/502,978

(22) PCT Filed: Nov. 18, 2015
(86) PCT No.: PCT/KR2015/012416

§ 371 Date: Feb. 9, 2017

(30) Foreign Application Priority Data
Apr. 7, 2015 (KR) 10-2015-0049317
Nov. 6, 2015 (KR) 10-2015-0155522
Nov. 18, 2015 (KR) 10-2015-0161453

(51) Int. Cl. E05C 17/46; E05B 15/02; E05F 5/06

(52) U.S. Cl. CPC E05C 17/46; E05F 5/06; E05B 15/029; E05Y 2900/132

(57) ABSTRACT

A hinged door fixing apparatus comprises a fixed part and a holder part. The fixed part is fixed on a wall such that, in order to prevent the doorknob or edge portion of a hinged door from bumping directly against the wall in the process of opening the hinged door, a buffer member having a buffer ball coupled to the end thereof, which is mounted to the hinged door, comes into contact with the fixed part in the opening process. The holder part is installed in the fixed part and instantaneously holds the buffer ball through elasticity when the buffer member bumps against the fixed part.

### TECHNICAL FIELD

The present invention relates to a hinged door fixing apparatus and, more particularly, to an apparatus for fixing a hinged door to prevent a hinged door that is generally used at home from accidentally slamming shut.

### BACKGROUND ART

In general, hinged doors that are pushed/pulled to open/close are generally used for convenience in homes except for the doors to relatively small spaces such as multipurpose rooms and a storage rooms for keeping various items, including a sub-door of a front door.

When a hinged door is opened, it may hit the wall on the opposite side and the door knob or the edge of the door may be damaged, so recently buffers are attached to the side of the hinged door that hits a wall.

Such buffers, in order to prevent damage to a door knob, have a support rod protruding further than the door knob and a buffer ball mounted at the end of the support rod to absorb shock. Further, the buffers are disposed at the upper portion of hinged doors so that they are not damaged by users even though they are used for long period of time.

Hinged doors with a safety device such as the above-described buffers are frequently accidentally slammed shut by wind from the outside when windows are open for cleaning of ventilating.

Accordingly, users use specific objects for supporting hinged doors or objects inserted between the doors and the floor to prevent this problem, but the users have to manually install such objects in this case.

### DISCLOSURE

### Technical Problem

An object of the present invention is to provide a hinged door fixing apparatus for preventing a hinged door that is used at home from slamming shut due to wind blowing inside from the outside.

### Technical Solution

In order to achieve the objects of the present invention, a hinged door fixing apparatus according to an embodiment of the present invention includes a base and a holder.

The base may be fixed to a wall to come in contact with a buffer having a buffer ball at an end and mounted on a hinged door when the hinged door opens, in order to prevent a doorknob or an edge of the hinged door from directly hitting against the wall when the hinged door opens. The holder may be combined with the base and instantaneously and elastically holds the buffer ball when the buffer hits against the base.

In order to achieve the objects of the present invention, a hinged door fixing apparatus, which is mounted on a wall to hold a buffer having a buffer ball at an end thereof and mounted on a hinged door to prevent a doorknob or an edge of the hinged door from directly hitting against the wall when the hinged door opens, includes first and second holding bars, an elastic module, and support members.

The first and second holding bars may be vertically spaced from each other with a predetermined gap to insert the buffer ball therebetween. The elastic module may be disposed between the first and second holding bars and may provide elasticity to insert and fix the buffer ball between the first and second holding bars. The support members may be disposed at both ends of the first and second holding bars so that the gap between the first and second holding bars is adjusted by the elastic module. The support members each may have: a first support plate having a first cam groove in which a first cam follower coupled to an end of the first holding bar is inserted; and a second support plate having a second cam groove that has a symmetric structure to the first cam groove and in which a second cam follower coupled to an end of the second holding bar is inserted.

In order to achieve the objects of the present invention, a hinged door fixing apparatus, which is mounted on a wall to hold a buffer having a buffer ball at an end thereof and mounted on a hinged door to prevent a doorknob or an edge of the hinged door from directly hitting against the wall when the hinged door opens, includes a housing plate, a pair of rollers, roller support members, and elastic members.

The housing plate may have a receiving groove defined by a bottom and sides and may have an inlet formed through the bottom to insert and pull out the buffer ball. The rollers may be disposed to face each other at the inlet in the receiving groove to hold the buffer ball that is inserted and pulled out. The roller support members may be respectively coupled to and cover both ends of the rollers such that the rollers can rotate in the receiving groove. The elastic members may provide elasticity to the roller support members between the roller support members and inner sides of the receiving groove.

### Advantageous Effects

According to the present invention, in order to prevent the doorknob or the edge of a hinged door from directly hitting against a wall when the hinged door opens, the buffer ball at the end of the buffer mounted on the hinged door is elastically and instantaneously held by the holder combined with the base fixed to the wall, so even though a user simply opens the hinged door, it is possible to prevent the hinged door from slamming shut due to wind from the outside.

Accordingly, the possibility of a user being surprised or injured by the hinged door slamming shut is precluded, so the user can more safely use the hinged door.

### DESCRIPTION OF DRAWINGS

FIG. 1 is a perspective view schematically showing a hinged door fixing apparatus according to an embodiment of the present invention.

FIG. 2 is a view showing in detail a holder of the hinged door fixing apparatus shown in FIG. 1.

FIG. 3 is a view schematically showing a hinged door fixing apparatus according to another embodiment of the present invention.

FIG. 4 is a perspective view schematically showing a hinged door fixing apparatus according to another embodiment of the present invention.

FIG. 5 is a cross-sectional view of a holding block of the hinged door fixing apparatus shown in FIG. 4.

FIG. 6 is a view schematically showing an interior space where a hinged door fixing apparatus according to another embodiment of the present invention is installed.

FIG. 7 is a view showing in detail the hinged door fixing apparatus shown in FIG. 6.

FIG. 8 is a view showing in detail first and second cam grooves of the hinged door fixing apparatus shown in FIG. 7.

FIGS. 9 to 13 are views showing in stages a process of fixing a buffer ball to a hinged door fixing apparatus.

FIG. 14 is a view schematically showing an interior space where a hinged door fixing apparatus according to another embodiment of the present invention is installed.

FIG. 15 is a view showing in detail the hinged door fixing apparatus shown in FIG. 14.

FIG. 16 is a view showing in detail the internal structure of a housing plate of the hinged door fixing apparatus shown in FIG. 15.

FIG. 17 is a view showing the structure of the housing plate shown in FIG. 16 without rollers, roller supports, and elastic members.

FIG. 18 is a view showing in detail a cover plate for covering the housing plate of the hinged door fixing apparatus shown in FIG. 15.

FIG. 19 is a view showing in detail a fixing plate coupled to the cover plate of the hinged door fixing apparatus shown in FIG. 15.

### BEST MODE

Hereinafter, hinged door fixing apparatuses for preventing a hinged door from being automatically closed according to embodiments of the present invention will be described in detail with reference to the accompanying drawings. The present invention may be modified in various ways and implemented by various exemplary embodiments, so that specific exemplary embodiments are shown in the drawings and will be described in detail. However, it should be understood that the present invention is not limited to the specific exemplary embodiments, but includes all modifications, equivalents, and substitutions included in the spirit and the scope of the present invention. Like reference numerals are given to like components in the description of the drawings. The sizes of the structures shown in the drawings are enlarged relatively to the real sizes to make the present invention clear.

Terms used in the specification, ‘first’, ‘second’, etc., may be used to describe various components, but the components are not to be construed as being limited to the terms. The terms are used to distinguish one component from another component. For example, the ‘first’ component may be named the ‘second’ component, and vice versa, without departing from the scope of the present invention.

Terms used in the present specification are used only in order to describe specific exemplary embodiments rather than limiting the present invention. As used herein, the singular forms are intended to include the plural forms as well, unless the context clearly indicates otherwise. It should be further understood that the terms “comprises”, “comprising”, “includes” and/or “including” when used herein, specify the presence of stated features, integers, steps, operations, elements, and/or components, but do not preclude the presence or addition of one or more other features, integers, steps, operations, elements, components, and/or groups thereof.

Unless otherwise defined, all terms including technical and scientific terms used herein have the same meaning as commonly understood by one of ordinary skill in the art to which the present invention belongs. It must be understood that the terms defined by the dictionary are identical with the meanings within the context of the related art, and they should not be ideally or excessively formally defined unless the context clearly dictates otherwise.

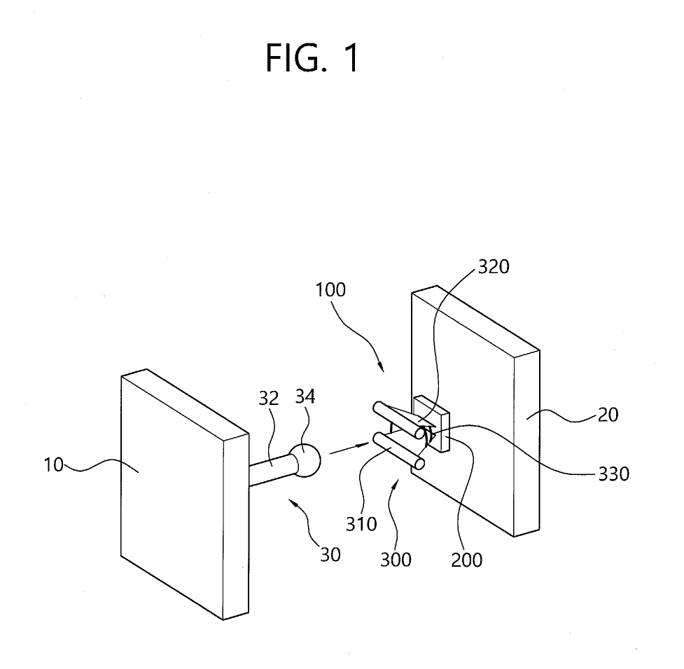

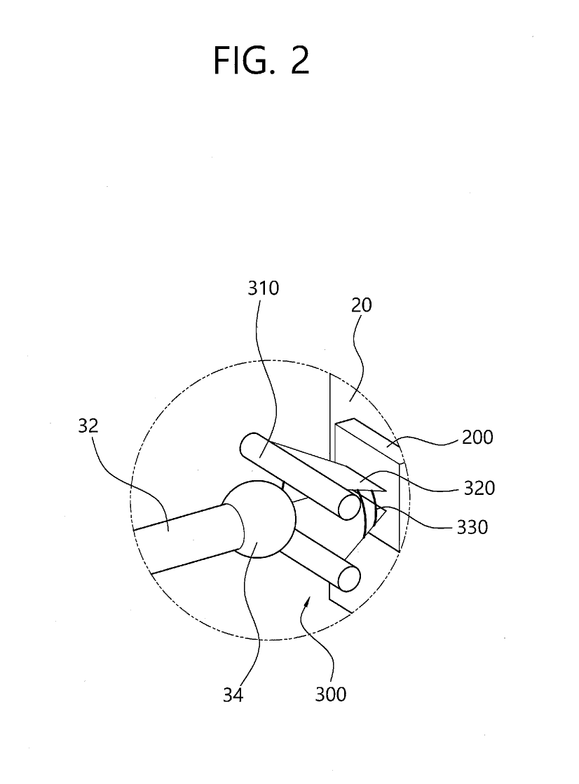

FIG. 1 is a perspective view schematically showing a hinged door fixing apparatus according to an embodiment of the present invention and FIG. 2 is a view showing in detail a holder of the hinged door fixing apparatus shown in FIG. 1.

Referring to FIGS. 1 and 2, a hinged door fixing apparatus 100 according to an embodiment of the present invention includes a base 200 and a holder 300.

The base 200 is fixed to a wall 20 that a hinged door 10 hits against when opening. A buffer 30 is mounted on the hinged door 10 to prevent the doorknob or the edge of the hinged door 10 from directly hitting against the wall 20 when the hinged door 10 opens. The buffer 30 includes a support rod 32 protruding further than the doorknob and a buffer ball 34 mounted at the end of the support rod 32 to absorb shock. The buffer ball 34 may be made of rubber having excellent shock-absorbing ability relative to the price.

The base 200, in detail, is fixed at the position where the buffer 30 comes in contact on the wall 20 when the hinged door 10 opens. Appropriate fasteners may be used for the base 200, depending on the material of the wall 20. For example, for the base 200, anchor pieces or concrete screws may be used when the wall 20 is made of cement, while drill pieces for wood or treenails may be used when the wall is made of wood. Unlikely, the base 200 may be integrally formed with the wall 20 in the process of manufacturing the wall 20.

The holder 300 is combined with the base 200. The holder 300 elastically and instantaneously holds the buffer ball 32 when the buffer 30 hits against the base 200. To this end, the holder 300 includes holding bars 310, guides 320, and elastic members 330.

Two holding bars 310 are spaced from each other to make a space for inserting the buffer ball 34 therebetween. In the holding bars 310, the surfaces that the buffer ball 34 comes in contact with when being inserted between the holding bars 310 may be curved to be able to smoothly guide the holding bars 310 that are inserted. Accordingly, the holding bars 310 may have a cylindrical shape. The two holding bars 310 have the same function, so they may have substantially the same shape.

The guides 320 are disposed between the holding bars 310 and the base 200. The guides 320 guide the holding bars 310 so that the space between the holding bars 310 is opened and closed when the buffer ball 34 is inserted into the space. Accordingly, the guides 320 may be hinged to the base 200 to smoothly guide the holding bars 310.

The guides 320, as shown in FIG. 2, may have a structure that simply connects the holding bars 310 and the base 200 in the shape of a plate, but may have a fan shape that covers the holding bars 310 or has coupling holes for coupling both ends of the holding bars 310.

The elastic members 330 are attached to the guides 320. The elastic members 330 are provided to apply elasticity to the holding bars 310 to close the holding bars 310. Accordingly, the elastic members 330 may be rubber bands or springs connected between the guides 320 connected with the holding bars 310, respectively.

As described above, in order to prevent the doorknob or the edge of the hinged door 10 from directly hitting against the wall 20 when the hinged door 10 opens, the buffer ball 34 at the end of the buffer 30 mounted on the hinged door 10 is elastically and instantaneously held by the holder 300 combined with the base 200 fixed to the wall 20, so even though a user simply opens the hinged door 10, it is possible to prevent the hinged door 10 from slamming shut due to wind from the outside.

Accordingly, the possibility of a user being surprised or injured by the hinged door 10 slamming shut is precluded, so the user can more safely use the hinged door 10.

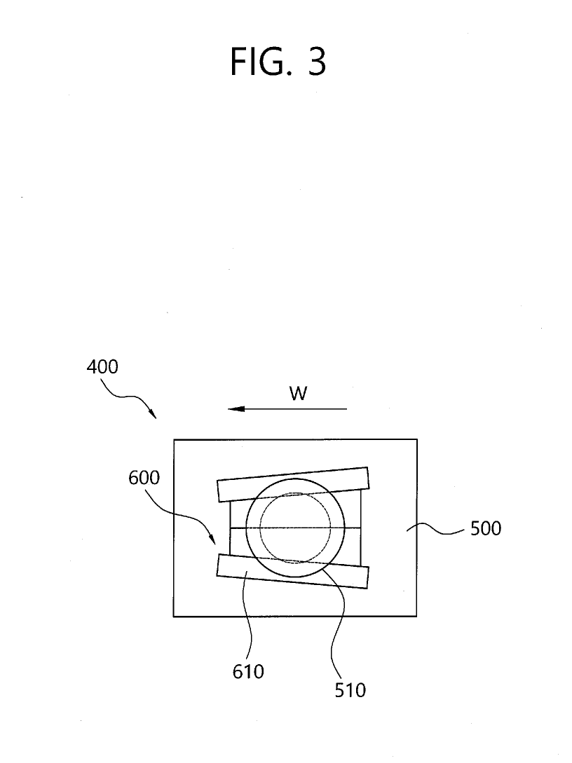

FIG. 3 is a view schematically showing a hinged door fixing apparatus according to another embodiment of the present invention.

This embodiment is substantially the same as the apparatus shown in FIGS. 1 and 2 except for the shape of the base, the structure of the holding bars, and the buffer corresponding to them, so the same configuration is not described in detail.

Referring to FIG. 3, the base 500 of a hinged door fixing apparatus 400 according to another embodiment of the present invention has a housing structure. Accordingly, a holder 600 is disposed in the housing. Since the base 500 has a housing structure, a simple external design can be achieved.

The base 500 has an insertion hole 510 in which the buffer ball (34 in FIG. 1) of the buffer (30 in FIG. 1) is inserted and holding bars 610 of the holder 600 are partially exposed. The insertion hole 510 may be structurally stably formed at the center of the base 500.

The gap between the holding bars 610 of the holder 600 may be decreased, as it goes to any side. According to this configuration, when the buffer ball (34 in FIG. 1) is inserted between the holding bars 610, it is guided in the space between the holding bars 610 by the narrowing shape, so it can be stably inserted and held.

Further, the narrowing direction of the gap between the holding bars 610 may be set in the inflow direction of wind W. According to this configuration, the buffer ball (34 in FIG. 1) can be more easily and stably inserted and held in the space between the holding bars 610. When the holding bars 610 are arranged such that the gap narrows in the inflow direction of wind W from the outside, the buffer ball (34 in FIG. 1) is guided into the narrowing part between the holding bars 610, so the buffer ball (34 in FIG. 1) can be more stably held by the holding bars 610. The buffer (30 in FIG. 1) is designed to allow the buffer ball (34 in FIG. 1) to move in the inflow direction of the wind W so that the buffer ball (34 in FIG. 1) is guided into the narrowing part between the holding bars 610 by the wind W, whereby the buffer ball (34 in FIG. 1) can be more stably held by the wind W.

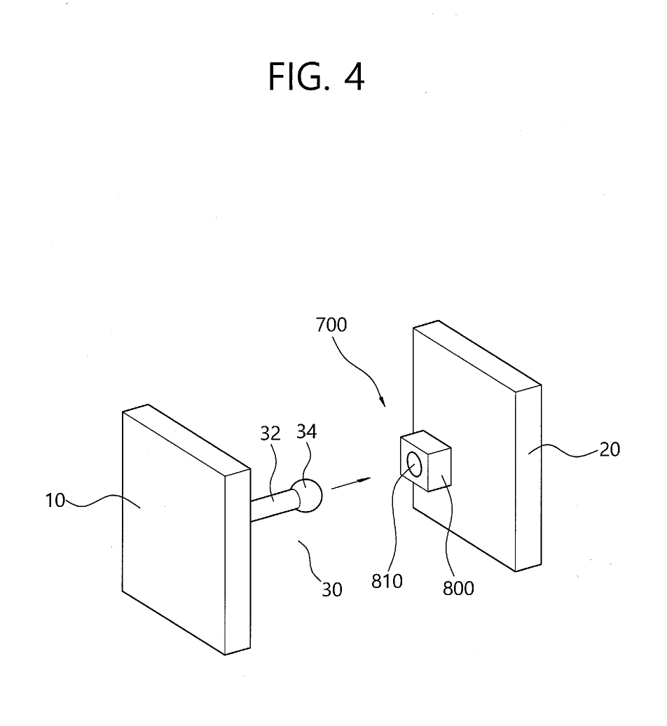

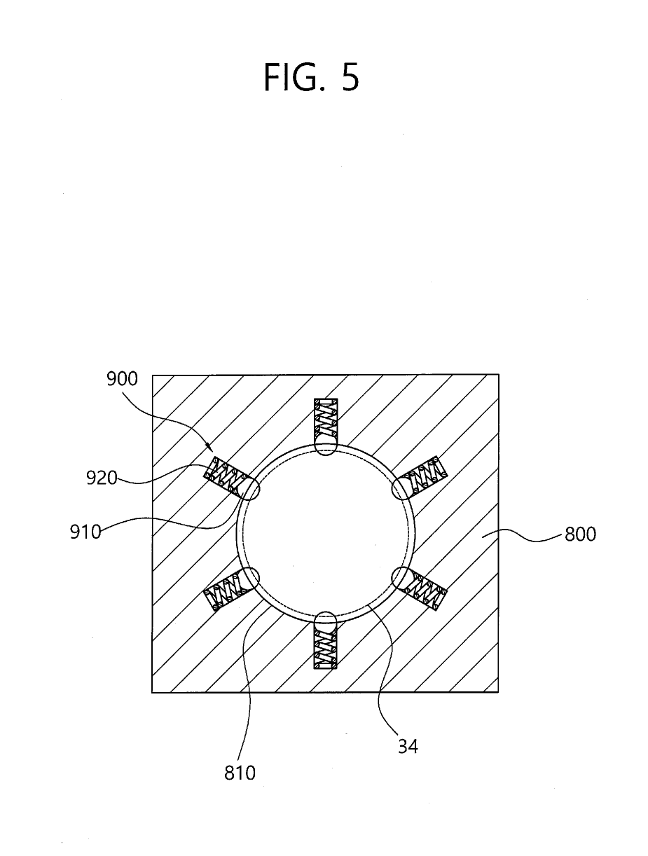

FIG. 4 is a perspective view schematically showing a hinged door fixing apparatus according to another embodiment of the present invention and FIG. 5 is a cross-sectional view of a holding block of the hinged door fixing apparatus shown in FIG. 4.

Referring to FIGS. 4 and 5, a hinged door fixing apparatus 700 according to another embodiment of the present invention includes a holding block 800 and at least one ball plunger 900.

The holding block 800 may be fixed to the wall 20, as an integral structure with the base (200 in FIG. 1) in the embodiment shown in FIGS. 1 and 2. The holding block 800 has an insertion hole 810 into which a buffer ball 34 of a buffer 30 mounted on the hinged door 10 is inserted. Accordingly, the holding block 800 may have a height larger than the diameter of the buffer ball 34 so that the buffer ball 34 can be fully inserted therein.

The ball plungers 900 are arranged inside the insertion hole 810 of the holding block 800. The ball plungers 900 each include a ball 910 partially protruding toward the insertion hole 810 and a spring 920 disposed inside the ball 910 and elastically pushing the ball 910 such that the ball 910 is exposed inside the insertion hole 810.

Accordingly, when the hinged door 10 opens, the buffer ball 34 can be inserted into the insertion hole 810 and simply held by elasticity of the ball plunger 900. The plungers 900 are arranged with regular intervals around and inside the insertion hole 810, so it is possible to more stably hold the buffer ball 34. The number of the ball plungers 900 substantially has a relationship with the force that inserts the buffer ball 34 and the force for holding the buffer ball 34, so the number can be determined in consideration of the relationship, depending on the installation conditions of the hinged door 10.

As described above, since the buffer ball 34 is held in the holding block 800 having the ball plungers 900 and the insertion hole 810, it is possible to simply prevent the hinged door 10 from slamming shut. Further, there is an additional advantage that the external appearance is simple through the one block and the possibility of the apparatus breaking down is relatively low.

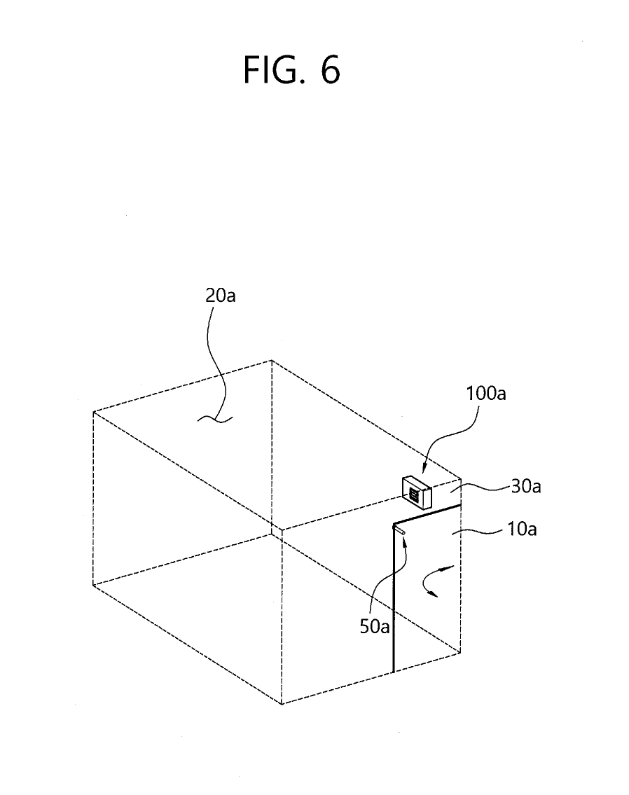

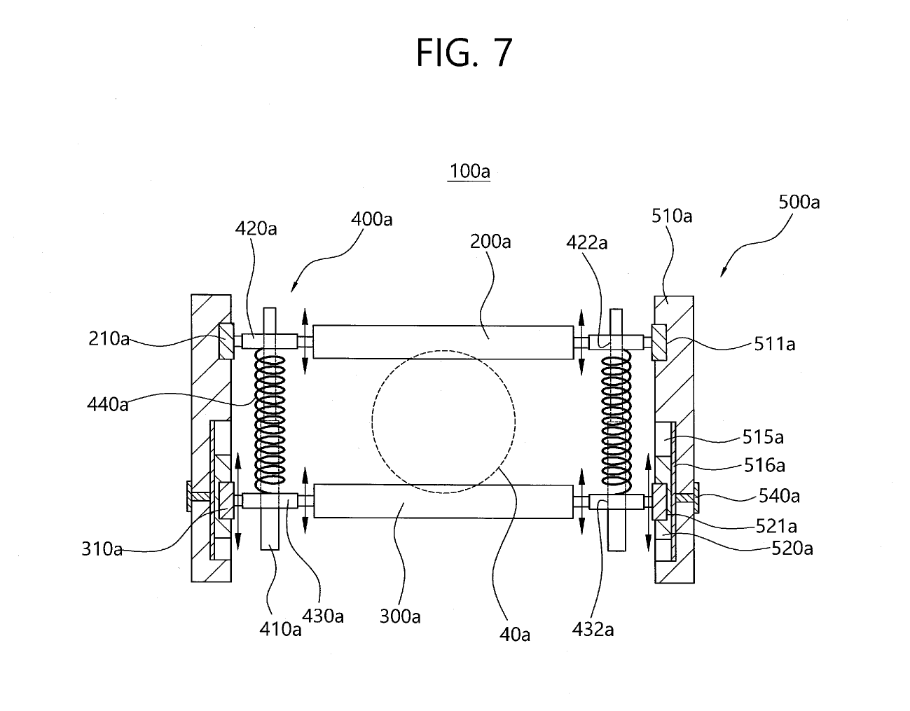

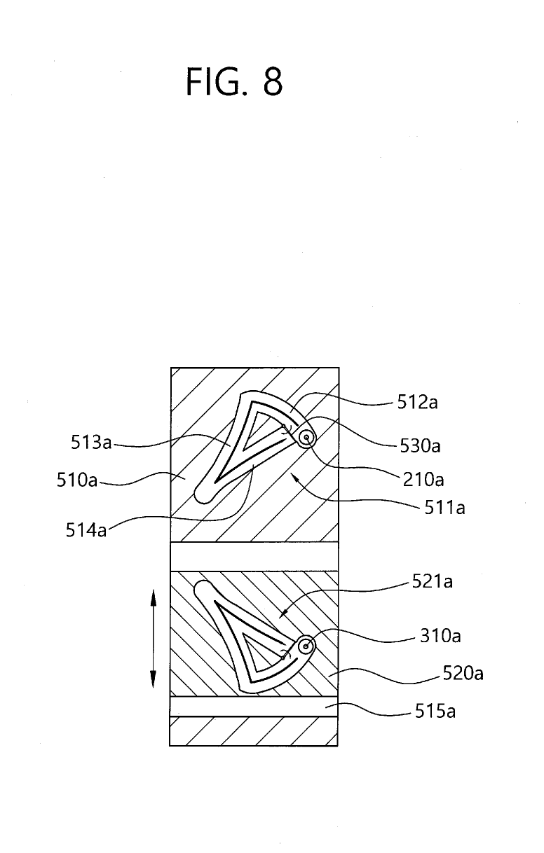

FIG. 6 is a view schematically showing an interior space where a hinged door fixing apparatus according to another embodiment of the present invention is installed, FIG. 7 is a view showing in detail the hinged door fixing apparatus shown in FIG. 6, and FIG. 8 is a view showing in detail first and second cam grooves of the hinged door fixing apparatus shown in FIG. 7.

Referring to FIGS. 6 to 8, a hinged door fixing apparatus 100a according to another embodiment of the present invention is mounted on a wall 30a of an interior space 20a to hold a buffer 50a having a buffer ball 40a at the end and mounted at the upper end of the hinged door 10a, in order to prevent the doorknob or the edge of the hinged door 10a from directly hitting against the wall 30a when the hinged door 10a opens. The hinged door fixing apparatus 100a includes first and second holding bars 200a and 300a, an elastic module 400a, and support members 500a.

The first and second holding bars 200a and 300a are vertically spaced with a gap so that the buffer ball 40a is inserted therebetween. Since the buffer ball 40a is made of rubber having a shock-absorbing ability, the first and second holding bars 200a and 300a can naturally freely rotate to reduce friction by the buffer ball 40a.

The elastic module 400a is disposed between the first and second holding bars 200a and 300a. The elastic module 400a provides elasticity to insert and fix the buffer ball 40a between the first and second holding bars 200a and 300a. Further, the elastic module 400a may be disposed between the first and second holding bars 200a and 300a to adjust the gap between the holding bars while the buffer ball 40a is inserted and fixed.

To this end, the elastic module 400a may include reference rods 410a, first blocks 420a, second blocks 430a, and elastic members 440a. The reference rods 410a are vertically disposed at both ends of the first and second holding bars 200a and 300a. The first blocks 420a are coupled to both ends of the first holding bar 200a and fitted on the reference rods 410a to be able to vertically move. In detail, the first blocks 420a each may have a first hole 422a at the center, through which the reference rod 410a passes, to move on the reference rod 410a. The second blocks 420a are, similar to the first blocks 420a, coupled to both ends of the second holding bar 300a and fitted on the reference rods 410a to be able to vertically move. In detail, similar to the first blocks 420a, the second blocks 430 each may have a second hole 432a through which the reference rod 410a passes. The elastic members 440a are disposed between the first and second blocks 420a and 430. The elastic members 440a provide elasticity between the first and second blocks 420a and 430a. In detail, the elastic members 440a may be extension springs and may be coupled to the first and second blocks 420a and 430a, with the reference rods 410a passing through them, to provide force that enables the first and second holding bars 200a and 300a to fix the buffer ball 40a.

In this embodiment, although the first and second blocks 420a and 430a are fitted on the reference rods 410a to be able to vertically move, the reference rods 410a may have a structure that can telescopically adjust its length with the first and second blocks 420a and 430a fixed to the reference rods 410a.

The support members 500a are coupled to both ends of the first and second holding bars 200a and 300a and support them so that the gap between the first and second holding bars 200a and 300a is adjusted by the elastic modules 400a.

The support members 500a may have a structure that supports the first and second holding bars 200a and 300a in a cam type to reduce elastic resistance from the elastic module 400a while the buffer ball 40a is inserted or pulled out.

In detail, the support members 500a each have a first support plate 510a having a first cam groove 511a in which a first cam follower 210a coupled to the end of the first holding bar 200a is inserted and a second support plate 520a having a second cam groove 521a that has a symmetric structure to the first cam groove 511a and in which a second cam follower 310a coupled to the end of the second holding bar 300a is inserted.

The first and second cam grooves 511a and 512a, in order to reduce the elastic resistance, as in FIG. 3, may have: first cam passages 512a that guide respectively the first and second cam followers 210a and 310a such that the first and second holding bars 200a and 300a open until the first and second holding bars 200a and 300a reach the center of the buffer ball 40a in the entering direction of the buffer ball 40a; second cam passages that continue from the first cam passages 512a and guide respectively the first and second cam followers 210a and 310a such that the first and second holding bars 200a and 300a close to hold the buffer ball 40a passing over the center; and third cam passages 514a that are connected to the starts of the first cam passages 512a from the ends of the second cam passages 513a and guide respectively the first and second cam followers 210a and 310a such that the first and second holding bars 200a and 300a open in the pulling-out direction of the buffer ball 40a.

The support members 500a each may further have an anti-reversing member 530a that is disposed at the joint between the third cam passage 514a and the first cam passage 512a to prevent the first cam follower 210a and the second cam follower 301a from being guided into the third cam passage 514a when the buffer ball 40a is inserted. Therefore, according to the hinged door fixing apparatus 100a, when the buffer ball 40a is inserted, the first and second cam followers 210a and 310a are guided into the third cam passages 514a, so the elastic resistance is further increased and it is possible to preclude the inconvenience of a user having to apply a large force.

Meanwhile, in order to adjust the gap between the first and second holding bars 200a and 300a when the size of the buffer ball 40a is changed, the support members 500a may each further have a fixing element 540a that couples the second support plate 520a to the first support plate 510a such that the second support plate 520a can vertically move, and fixes the second plate 520a at a desired position on the first support plate 510a. The fixing element 540a may simply fix the second support plate 520a in a push button type or a bolt type manner. Further, an insertion groove 515a in which the second support plate 520a is inserted may be formed on the first support plate 510a to prevent the second support plate 520a that vertically moves from protruding toward the first and second holding bars 200a and 300a. Further, a rail 516a may be disposed in the insertion groove 515a to allow the second support plate 520a to vertically move.

As described above, the first and second holding bars 200a and 300a are guided along the first and second cam grooves 511a and 521a shown in FIG. 3, with the elastic module 400a therebetween, thereby receiving and fixing the buffer ball 40a coupled to the end of the buffer 50a mounted at the upper end of the hinged door 10a, so that it is possible to minimize elastic resistance that is generated when the buffer ball 40a is fixed in or separated out of the hinged door fixing apparatus 100a. Therefore, a user can more naturally fix the buffer ball 40a in the hinged door fixing apparatus 100a without general inconvenience.

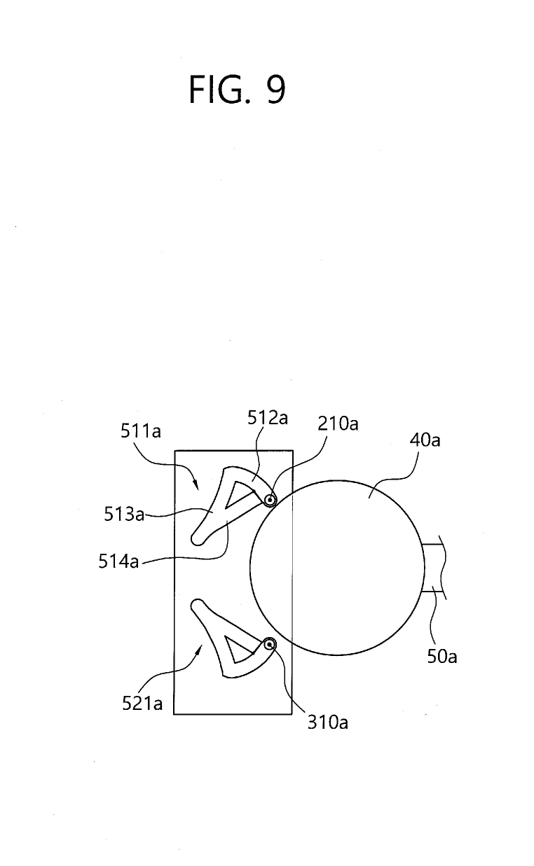

Hereinafter, the process of the buffer ball 40a being inserted into or pulled out of the gap between the first and second holding bars 200a and 300a is described in detail with reference to FIGS. 9 to 13.

FIGS. 9 to 13 are views showing in stages a process of fixing a buffer ball to a hinged door fixing apparatus.

Referring to FIG. 9, in order to insert and fix the buffer ball 40a, the buffer ball 40a is prepared to be inserted between the first and second holding bars 200a and 300a.

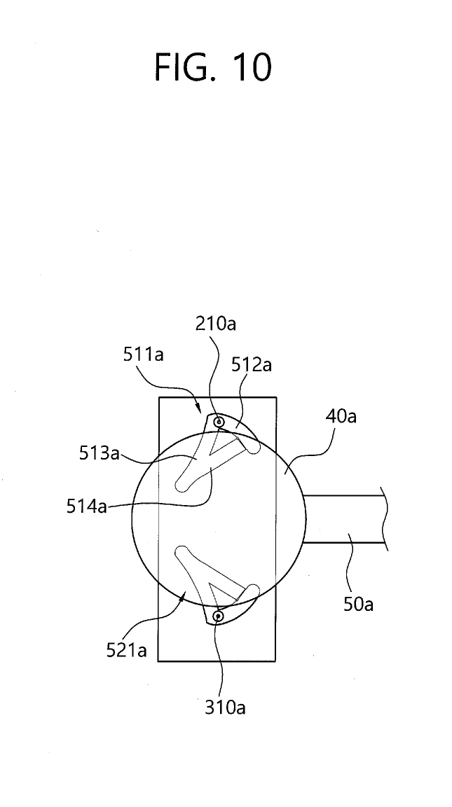

Referring to FIG. 10, when a user applies a force that pushes the buffer ball 40a, the first and second cam followers 210a and 310a coupled to the first and second holding bars 200a and 300a, respectively, are guided along the first cam passages 512a and the first and second holding bars 200a and 300a naturally open.

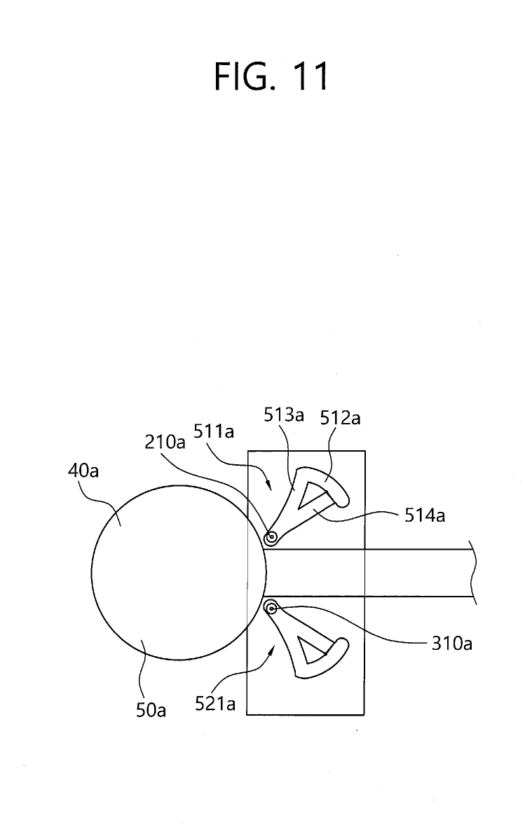

Referring to FIG. 11, when the first and second holding bars 200a and 300a pass over the center of the buffer ball 40a, the first and second cam followers 210a and 310a are guided along the second cam passages 513a and the first and second holding bas 200a and 300a close and more strongly fix the rear portion of the buffer ball 40a.

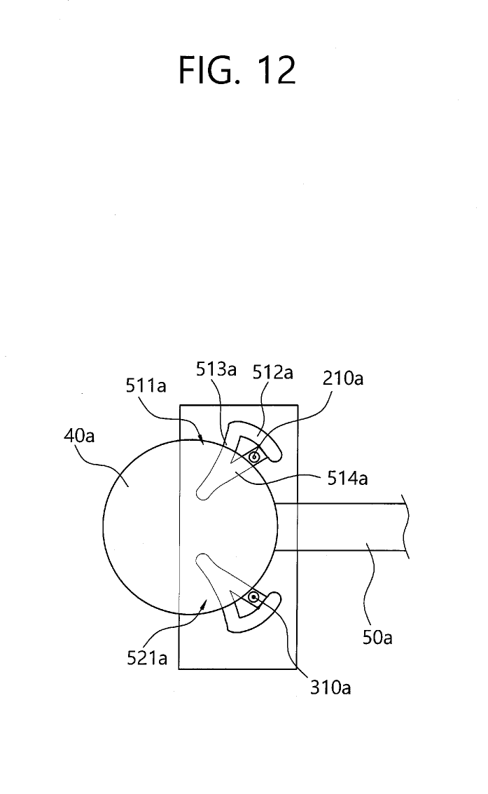

Referring to FIG. 12, when a user intends to separate the buffer ball 40a from the first and second holding bars 200a and 300a, the first and second cam followers 210a and 310a are guided along the third cam passages 514a and the first and second holding bars 200a and 300a naturally open.

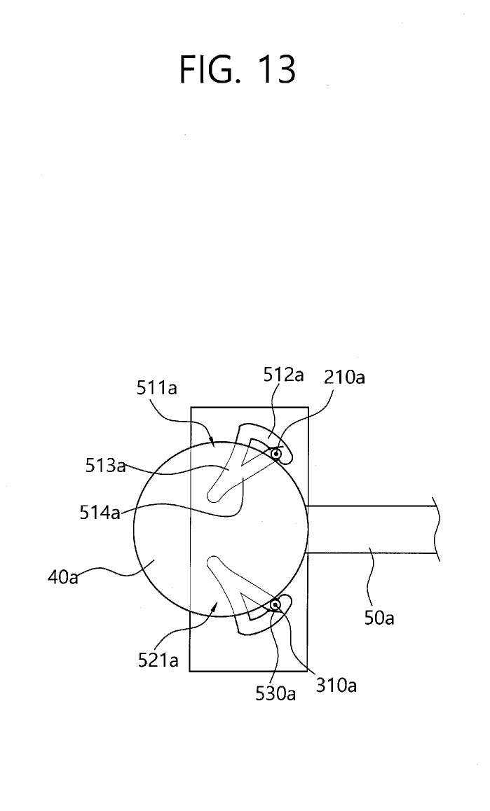

Referring to FIG. 13, when the cam followers 210a and 310a pass the joints between third cam passages 514a and the second cam passages 513a while the buffer ball 40a is separated from the first and second holding bars 200a and 300a, the anti-reversing members 530a are instantaneously opened and then closed, so even if the buffer ball 40a is inserted back into the gap between first and second holding bars 200a and 300a, the first and second cam followers 210a and 310a can be prevented from being guided into the third cam passages 514.

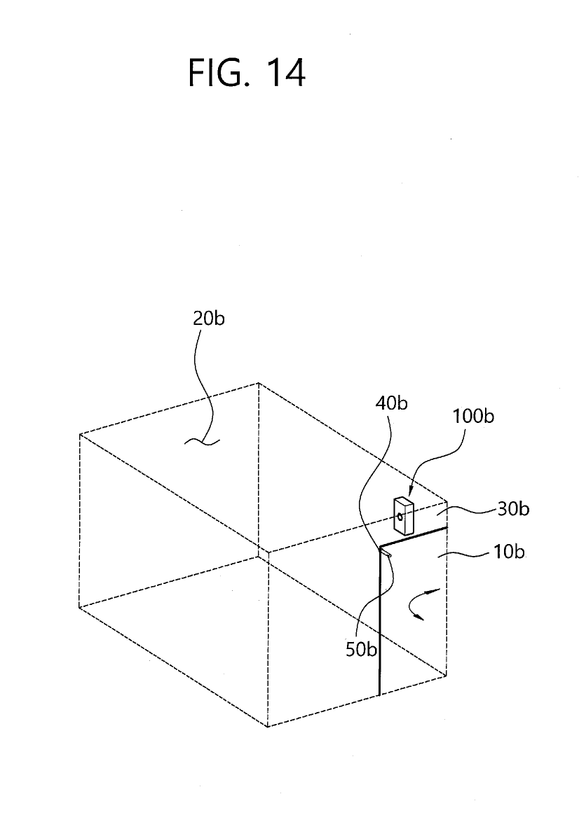

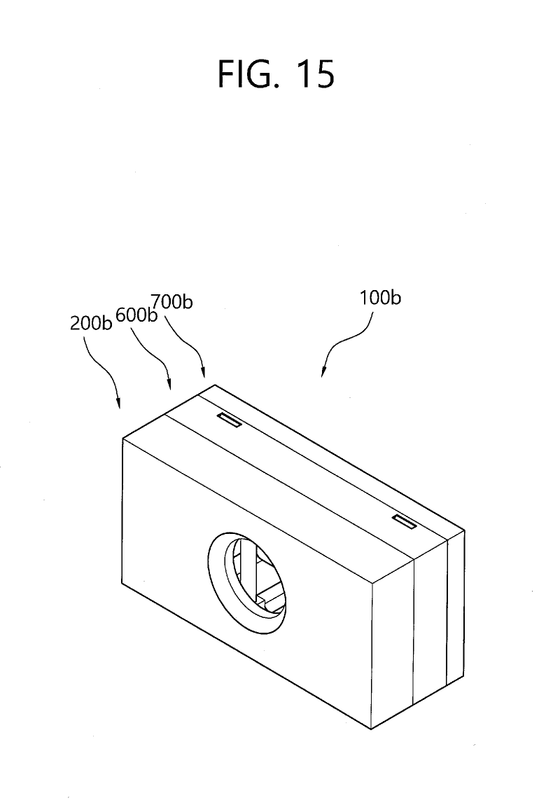

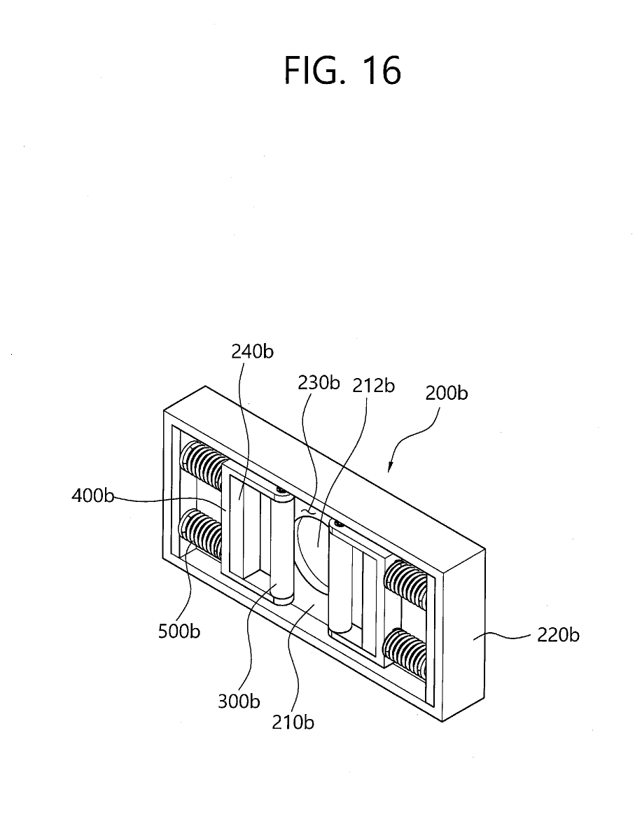

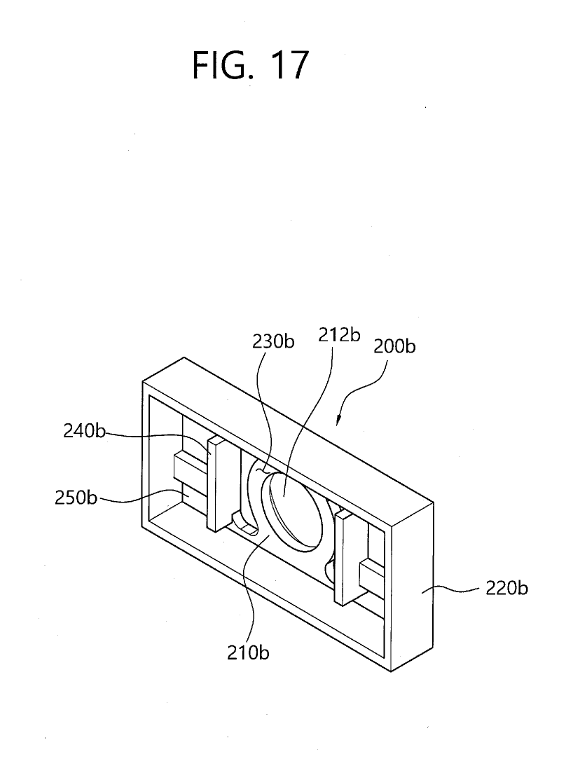

FIG. 14 is a view schematically showing an interior space where a hinged door fixing apparatus according to another embodiment of the present invention is installed, FIG. 15 is a view showing in detail the hinged door fixing apparatus shown in FIG. 14, FIG. 16 is a view showing in detail the internal structure of a housing plate of the hinged door fixing apparatus shown in FIG. 15, and FIG. 17 is a view showing the structure of the housing plate shown in FIG. 16 without rollers, roller supports, and elastic members.

Referring to FIGS. 14 to 17, a hinged door fixing apparatus 100b according to another embodiment of the present invention is mounted on a wall 30b of an interior space 20a to hold a buffer 50b having a buffer ball 40b at the end and mounted at the upper end of a hinged door 10b, in order to prevent the doorknob or the edge of the hinged door 10b from directly hitting against the wall 30b when the hinged door 10b opens. The hinged door fixing apparatus 100b includes a housing plate 200b, a pair of rollers 300b, a pair of roller support members 400b, and at least a pair of elastic members 500b.

The housing plate 200b has a receiving groove 230b defined by a bottom 210b and sides 220b protruding from the edge of the bottom 210b. The housing plate 200b has an inlet 212b formed through the bottom 210b to insert and pull out the buffer ball 40a. Since the buffer ball 40b has a circular structure, the inlet 212b may have a circular or an elliptical structure having a diameter larger by a predetermined size than the buffer ball 40b.

The rollers 300b are circular rods or tubes and disposed laterally in the receiving groove 230b. In detail, the rollers 300b may be disposed to face each other at the inlet 212 to hold the buffer ball 40b being inserted and pulled out. The rollers 300b may be arranged in parallel with each other, but if necessary, they may be arranged to narrow in any one direction. The rollers 300b may be made of metal having high strength not to be damaged by the buffer ball 40b that is repeatedly inserted and pulled out.

The roller support members 400b are disposed in the receiving groove 230b. In detail, the roller support members 400b may be coupled to and cover both ends of the rollers 300b, respectively, such that the rollers 300b can rotate. The roller support members 400b may almost contact with the inner sides 220b facing each other of the receiving groove 230b of the housing plate 200b to stably guide the rollers 300b when the buffer ball 40b is inserted and pulled out through the inlet 212. The roller support members 400b are, similar to the rollers 300b, directly operated when the buffer ball 40b is repeatedly inserted and pulled out, so they may be made of metal having high strength.

The elastic members 500b are disposed respectively between the roller support members 400b and the inner sides 220b of the receiving groove 230b. The elastic members 500b provide elasticity so that the rollers 300b can hold the buffer ball 40b that is inserted and pulled out. For example, the elastic members 500b may be compression springs. It should be understood that the tension and the number of the elastic members 500b that are the compression springs can be freely changed, depending on the installation space and the size of the buffer ball 40b.

As described above, in the structure composed of the rollers 300b, the roller support members 400b, and the elastic members 500b, the housing plate 200b may further include stoppers 240b for stopping the roller support members 400b so that the rollers 300b are maintained with a predetermined gap therebetween in the receiving groove 230b. The stoppers 240b may be formed on the bottom of the receiving groove 230b for the structure of the roller support members 400b described above. In detail, the stoppers 230b may protrude from the bottom 210b, inside the roller support members 400b, as shown in FIGS. 16 and 17.

Further, the housing plate 200b may have guide grooves 250b on the bottom 210b to naturally guide the elastic members 500b that are compression springs when the roller support members 400b are operated by the buffer ball 40b that is repeatedly inserted and pulled out.

As described above, the buffer ball 40b coupled to the end of buffer 50b mounted at the upper end of the hinged door 10b to prevent the doorknob or the edge of the hinged door 10b from directly hitting against the wall 30b when the hinged door 10b opens is held by the pair of rollers 300b rotatably coupled to the roller support members 400b and receiving elasticity from the elastic members 500b. Accordingly, it is possible to minimize the friction when the buffer ball 40b is inserted and pulled out, through the rotatable structure of the rollers 300b. Therefore, as the friction is minimized, a user can more easily fix/separate the hinged door 10b to/from the wall 30b.

Further, since the stoppers 240b for stopping the roller support members 400b and the guide grooves 240b for guiding thee elastic members 500b are integrally formed with one housing plate 200b, the number of parts of the hinged door fixing apparatus 100b is minimized, so more convenient assembly can be expected.

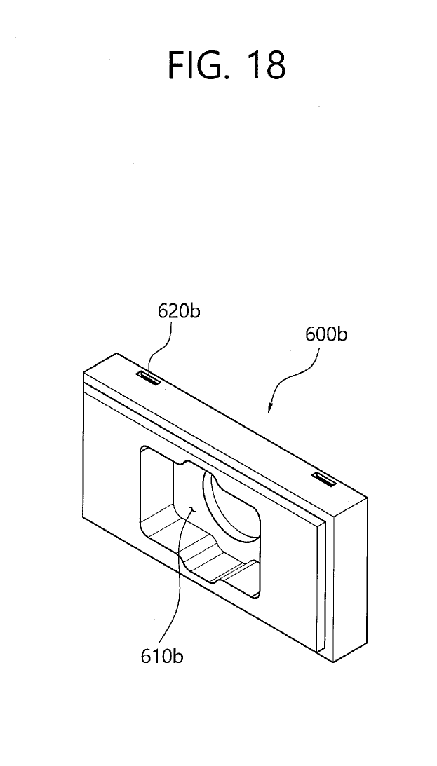

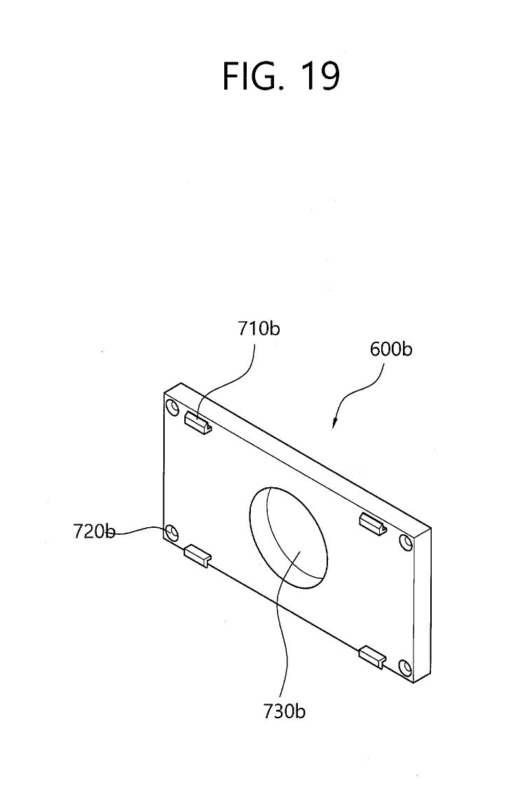

Hereinafter, the cover plate 600b and the fixing plate 700b are described in detail with reference to FIGS. 18 and 19.

FIG. 18 is a view showing in detail a cover plate for covering the housing plate of the hinged door fixing apparatus shown in FIG. 15 and FIG. 19 is a view showing in detail a fixing plate coupled to the cover plate of the hinged door fixing apparatus shown in FIG. 15.

Referring to FIGS. 18 and 19, the cover plate 600b is combined with the housing plate 200b to cover the receiving groove 230b. In detail, the cover plate 600b may be combined with the housing plate 200b by fasteners (not shown) such as bolts or rivets or by hooks in a direct way. According to this configuration, it is possible to prevent the parts in the receiving groove 230b of the housing plate 200b from separating from the receiving groove 230b. The cover plate 600b has a communicating hole 610b, which communicates with the inlet 212, at the center to pass the buffer ball 40b that is inserted and pulled out.

The fixing plate 700b is combined with the cover plate 600b in hook-type and fixed to the wall 30b. In detail, hooks 710b facing opposite directions at corresponding positions may be formed on the fixing plate 700b and hook grooves 620b in which the hooks 710b are inserted are formed at positions corresponding to the hooks 710 in the cover plate 600b. Further, the fixing plate 700b may have fixing holes 720b to be stably fixed to the wall 30b by fasteners (not shown) such as anchor pieces. Accordingly, a user can stably and simply mount the hinged door fixing apparatus 100b of the present invention on the wall 30b by fixing the fixing plate 700b first to the wall 30b in the way described above, and then simply fasten the cover plate 600b combined with the housing plate 200b to the fixing plate 700b using the hooks. A first communicating hole 730b that communicates with the communicating hole 610b to check the position where the buffer ball 40b hits against the wall 30b may be formed through the fixing plate 700b.

Although the present invention was described above through exemplary embodiments, it would be understood by those skilled in the art or ordinary people in the art that the present invention may be changed and modified in various ways without departing from the spirit and scope of the present invention described in the following claims.

### INDUSTRIAL APPLICABILITY

As described above, in order to prevent the doorknob or the edge of a hinged door from directly hitting against a wall when the hinged door opens, the buffer ball at the end of a buffer mounted on the hinged door is instantaneously and elastically held by the holder on the base fixed to the wall, thereby preventing the hinged door from slamming shut due to wind from the outside. Therefore, the present invention can be used to ensure safety of hinged doors that are generally used.

1-17. (canceled)

18. A hinged door fixing apparatus comprising:
a base fixed to a wall to come in contact with a buffer having a buffer ball at an end thereof and mounted on a hinged door when the hinged door opens, in order to prevent a doorknob or an edge of the hinged door from directly hitting against the wall when the hinged door opens; and
a holder combined with the base and instantaneously and elastically holding the buffer ball when the buffer hits against the base,
wherein the holder includes:
holding bars spaced from each other to form a space for inserting the buffer ball therebetween;
guides disposed respectively between the holding bars and the base, guiding the holding bars such that the space is adjusted depending on whether the buffer ball is inserted, and hinged to the base; and
elastic members disposed between the guides and providing elasticity for instantaneously holding the buffer ball when the buffer ball is inserted into the space to the holding bars through the guides.

19. The apparatus of claim 18, wherein the base has a housing structure to accommodate the holding bars of the holder and has an insertion hole in which the buffer ball is inserted and the holding bars are partially exposed to the outside.

20. A hinged door fixing apparatus that is mounted on a wall to hold a buffer having a buffer ball at an end thereof and mounted on a hinged door to prevent a doorknob or an edge of the hinged door from directly hitting against the wall when the hinged door opens, the apparatus comprising:
first and second holding bars vertically spaced from each other with a predetermined gap to insert the buffer ball therebetween;
an elastic module disposed between the first and second holding bars and providing elasticity to insert and fix the buffer ball between the first and second holding bars; and
support members disposed at both ends of the first and second holding bars so that the gap between the first and second holding bars is adjusted by the elastic module,
wherein the support members each have:
a first support plate having a first cam groove in which a first cam follower coupled to an end of the first holding bar is inserted; and
a second support plate having a second cam groove that has a symmetric structure to the first cam groove and in which a second cam follower coupled to an end of the second holding bar is inserted.

21. The apparatus of claim 20, wherein the second support plates are coupled to the first support plates to be vertically movable and the support members further include respective fixing elements for fixing the second support plates at predetermined positions on the first support plates.

22. The apparatus of claim 20, wherein the first and second cam grooves respectively have:
first cam passages respectively guiding the first and second cam followers such that the first and second holding bars open until the first and second holding bars reach a center of the buffer ball in an entering direction of the buffer ball; and
second cam passages respectively continuing from the first cam passages and guiding the first and second cam followers such that the first and second holding bars close to hold the buffer ball passing over the center.

23. The apparatus of claim 22, wherein the first and second cam grooves respectively further have third cam passage respectively connected to starts of the first cam passages from ends of the second cam passages and respectively guiding the first and second cam followers such that the first and second holding bars open in a pulling-out direction of the buffer ball.

24. The apparatus of claim 23, wherein the support members further have an anti-reversing member disposed at a joint between the third cam passage and the first cam passage and preventing the first cam follower or the second cam follower from entering the third cam passage when the buffer ball is inserted.

25. The apparatus of claim 20, wherein the elastic module includes:
reference rods vertically disposed at both ends of the first and second holding bars;
first blocks coupled respectively to both ends of the first holding bar and fitted on the reference rods to be vertically movable;
second blocks coupled respectively to both ends of the second holding bar and fitted on the reference rods to be vertically movable; and
elastic members disposed between the first blocks and the second blocks and providing elasticity between the first blocks and the second blocks.

26. The apparatus of claim 20, wherein the elastic module includes:
first blocks coupled respectively to both ends of the first holding bars;
second blocks coupled respectively to both ends of the second holding bar;
reference rods disposed between the first blocks and the second blocks to be able to adjust a length; and
elastic members fitted on the reference rods and providing elasticity between the first blocks and the second blocks.

27. A hinged door fixing apparatus that is mounted on a wall to hold a buffer having a buffer ball at an end thereof and mounted on a hinged door, which opens and closes an internal space with a window and slams shut due to wind flowing inside through the window, in order to prevent a doorknob or an edge of the hinged door from directly hitting against the wall when the hinged door opens, and that keeps the hinged door open to prevent the hinged door from slamming shut by wind flowing between the wall and the open hinged door from the wind, the apparatus comprising:
a housing plate having a receiving groove defined by a bottom and sides and having an inlet formed through the bottom to insert and pull out the buffer ball;
a pair of long rollers disposed to face each other at the inlet in the receiving groove to hold the buffer ball that is inserted and pulled out;
roller support members respectively coupled to and covering both ends of the rollers such that the rollers can rotate in the receiving groove; and
elastic members providing elasticity to the roller support members between the roller support members and inner sides of the receiving groove,
wherein the roller supports are in close contact with inner surfaces of facing side of the receiving groove and are guided when the buffer balls is inserted and pulled out through the inlet,
the housing plate includes stoppers protruding from the bottom, inside the roller support members, to stop the roller support members such that the rollers are maintained with a predetermined gap therebetween in the receiving groove,
the housing plate has guide grooves for guiding the elastic members on the bottom, and
the apparatus further includes a cover plate combined with the housing plate to cover the receiving groove.

28. The apparatus of claim 27, further comprising a fixing plate for fixing the apparatus to the wall through a structure that is combined with and separated from the cover plate in hook-type.
